(19) United States
(12) Patent Application Publication
(10) Pub. No.: US 2018/0236629 A1
(43) Pub. Date: Aug. 23, 2018

(54) Handle Adjustable Power Hand Tool

(71) Applicant: Manuel Gonzalez, Lake Jackson, TX (US)

(72) Inventor: Manuel Gonzalez, Lake Jackson, TX (US)

(21) Appl. No.: 15/900,719

(22) Filed: Feb. 20, 2018

Related U.S. Application Data
(60) Provisional application No. 62/461,684, filed on Feb. 21, 2017.

(51) Int. Cl. B24B 23/00; B25F 5/02; B24B 23/02

(52) U.S. Cl. CPC B24B 23/005; B24B 23/028; B25F 5/02

(57) ABSTRACT

A hand held power tool having a non-removable handle. The handle may be positioned in two or more fixed positions during operation of the hand held power tool.

### CROSS-REFERENCE TO RELATED APPLICATIONS

This non-provisional patent application claims the benefit of and priority from U.S. provisional patent application No. 62/461,684 filed Feb. 21, 2017.

### STATEMENT REGARDING FEDERALLY SPONSORED RESEARCH OR DEVELOPMENT

Not applicable.

### FIELD OF THE INVENTION

The application relates generally to a tamper-proof handle for hand held power tools.

### BACKGROUND OF THE INVENTION

Operators of hand held power tools such as angle grinders often have to change the orientation and/or position of the tool in confined spaces and/or body posture as necessary to perform a particular task. In addition, operators often remove component parts such as side handles from tools to obtain sufficient working space. Depending on the location of tool operation, one or more laws, rules, standards and/or regulations may govern the operation of such tools and many locations consider the removal of various component parts as a safety violation. Violations of this sort are not always easy to prevent and employers are always looking for ways to improve safety and minimize safety violations and any fines/penalties related thereto. As an example, commercially available angle grinders include removable side handles that may be attached on either side of the grinder body providing for right handed and left handed operation. However, the removability of a side handle provides grinder operators an opportunity to remove the side handle altogether to perform a grinding operation faster and/or easier regardless of safety violations. Overcoming aforesaid problem of a removable handle is desired.

### SUMMARY OF THE INVENTION

The present application is directed to a hand held power tool including a non-removable side handle adjustable between two or more fixed positions about the hand held power tool. The hand held power tool may include an inner channel operationally configured to receive part of the side handle therein, the inner channel extending at least 180.0 degrees about the hand held power tool.

The present application is also directed to a hand held power tool including a tamper-proof side handle assembly adjustable between two or more fixed positions about the power hand tool. The hand held power tool may include an inner channel operationally configured to receive part of the side handle assembly therein. The side handle assembly may include a projection member operationally configured to travel within the inner channel. The hand held power tool may include two or more apertures for receiving part of the side handle assembly therein. The two or more apertures may be provided as threaded apertures.

The present application is also directed to an angle grinder including a non-removable side handle, the angle grinder having a channel at a depth within the grinder operationally configured to receive at least part of the side handle therein in a manner effective to fix the side handle in two or more positions about the angle grinder up to 180.0 degrees. The channel of the grinder may be formed by an assembly of individual component parts of the angle grinder.

### BRIEF DESCRIPTION OF THE SEVERAL VIEWS OF THE DRAWING

FIG. 1 is a front perspective view of a prior art angle grinder.

FIG. 2 is a front perspective view of a prior art angle grinder.

FIG. 3 is a top view of an embodiment of an angle grinder of the present application.

FIG. 4 is a front perspective partial phantom view of the angle grinder of FIG. 3.

FIG. 5 is an exploded view of a second section of the angle grinder of FIG. 3.

FIG. 6 is an exploded view of an embodiment of a side handle assembly of the present application.

FIG. 7 is an elevated side view of an end cap of a handle of a side handle assembly.

FIG. 8 is an elevated side view of an embodiment of an assembled side handle assembly of the present application.

FIG. 9 is a partial phantom elevated side view of an assembled side handle assembly of the present application.

FIG. 10 is another front perspective view of the angle grinder of FIG. 3.

FIG. 11 is a perspective view of an embodiment of a tracking body member.

FIG. 12 is a front perspective view of another embodiment of an angle grinder of the present application.

FIG. 13 is an exploded view of an embodiment of a side handle assembly.

FIG. 14 is a perspective cut away view of the handle of FIG. 13.

FIG. 15 is a cross-sectional side view of an embodiment of an intermediate housing of the present application.

FIG. 16 is a perspective view of an assembled side handle assembly of FIG. 13.

FIG. 17 is a perspective cut away view of the side handle assembly and part of the angle grinder of FIG. 12.

FIG. 18 is another perspective cut away view of the side handle assembly and part of the angle grinder of FIG. 12.

FIG. 19 is a perspective cut away view of another embodiment of a side handle assembly and part of the angle grinder of FIG. 12.

FIG. 20 a perspective cut away view of another embodiment of a side handle assembly and part of the angle grinder of FIG. 12.

FIG. 21 is a partial phantom top view of another embodiment of an angle grinder of the present application.

FIG. 22 is a cross-sectional view of an embodiment of an angle grinder and a side handle assembly attached thereto.

FIG. 23 is a cross-sectional view of a handle of the side handle assembly of FIG. 22.

FIG. 24 is a cross-sectional view of an intermediate housing of the side handle assembly of FIG. 22.

FIG. 25 is a side view of a locking shaft of the side handle assembly of FIG. 22.

### DETAILED DESCRIPTION

Before describing the invention in detail, it is to be understood that the present invention is not limited to particular embodiments. It is also to be understood that the terminology used herein is for the purpose of describing particular embodiments only and is not intended to be limiting. As used in this specification and the appended claims, the phrase “hand held power tool” refers to hand held corded and/or cordless power hand tools including, but not necessarily limited to oscillating power tools, rotary power tools, saw power tools, angle grinders, straight grinders, concrete surfacing grinders, cutoff tools, tuckpointing grinders, hand drills, hammer drills, reciprocating saws, sheet sanders, orbital sanders, electric stone wet polishers and buffer/polishers. In regard to side handles used with hand held power tools, the phrases “tamper-proof” and “tamper resistant” refer to a side handle or side handle assembly that may not be removed, i.e., “non-removable,” from a hand held power tool while the power tool is in an operable state for its intended purpose. The phrase “power hand tool” may be used interchangeably with “hand held power tool.”

In one aspect, the application provides a non-removable side handle for hand held power tools. In another aspect, the application provides a non-removable adjustable side handle for hand held power tools. In another aspect, the application provides a non-removable side handle assembly for hand held power tools. In another aspect, the application provides a non-removable adjustable side handle assembly for hand held power tools. Although the present application is discussed in terms of hand held power tools, it is understood that the invention of this application may be built to scale as desired.

In another aspect, the application provides a non-removable side handle for portable hand held power tools such as angle grinders including large angle grinders, medium angle grinders and small angle grinders. In one embodiment, the angle grinder may include a side handle positioner assembly operationally configured to locate a side handle in a plurality of locations about the angle grinder.

In another aspect, the application provides a side handle assembly for a portable power tool that may be releasably directed between a plurality of set positions for changing the location of the handle in relation to the power tool during operation of the power tool. The side handle assembly may not be removed from the power tool without disassembly of the power tool into its individual component parts.

In another aspect, the application provides a power hand tool including a non-removable side handle adjustable between two or more fixed positions.

In another aspect, the application provides a hand held power tool including a non-removable side handle positionable at two or more locations during tool operation.

In another aspect, the application provides an angle grinder including individual component parts such as a first body section, a second gear section and a third handle positioner assembly disposed between the body section and gear section, the handle assembly providing a tamper-proof or non-removable side handle fixable in operable set positions on opposing sides of the angle grinder.

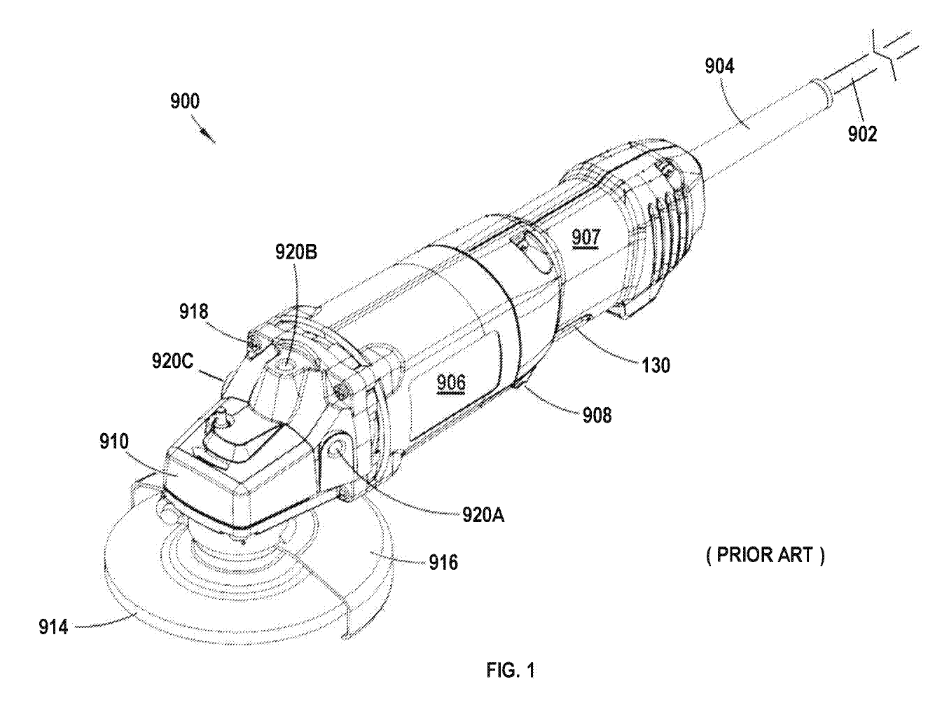

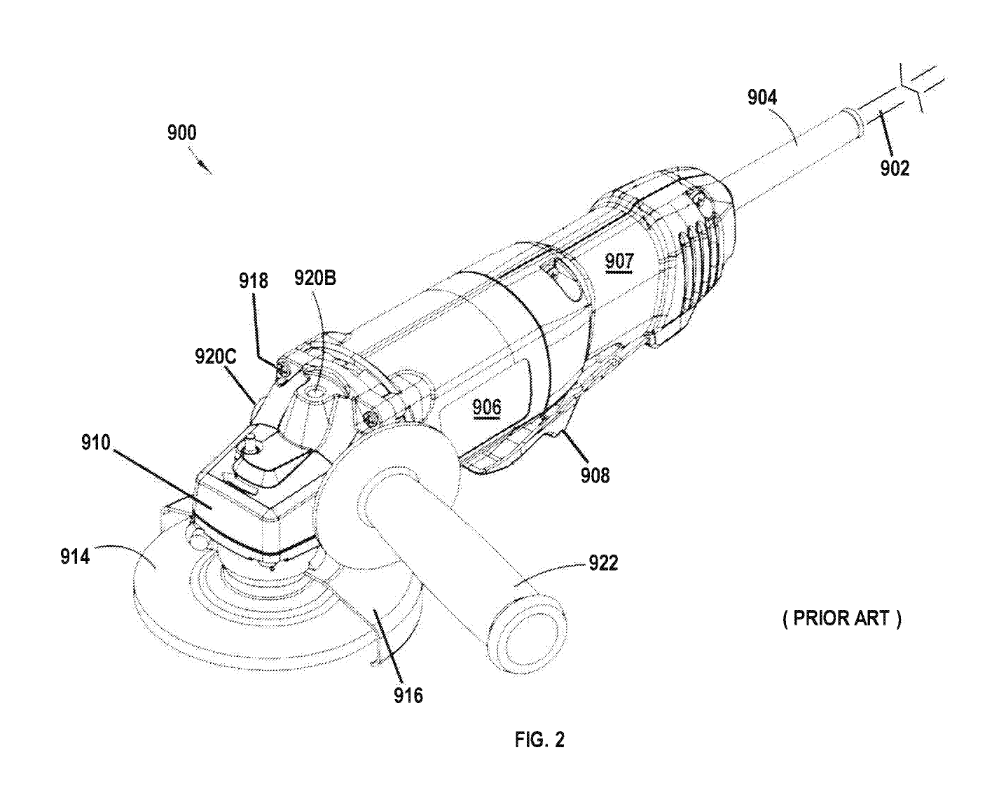

With reference to FIGS. 1 and 2, one exemplary prior art angle grinder 900 known to the skilled artisan is provided as described in U.S. Pat. No. 6,120,362, entitled “Ergonomic Grinder,” with an issue date of Sep. 19, 2000, the content of which is herein incorporated by reference in its entirety. As shown in FIGS. 1 and 2, an angle grinder of this sort is typically powered via an electrical motor run by line power through a line cord 902, which is typically secured to the angle grinder with a cord set reinforcing member 904. Other similar angle grinders may be provided with a battery-powered electrical motor or an air motor as known to persons of ordinary skill in the art of hand held power tools. As further shown in FIGS. 1 and 2, a common angle grinder 900 includes (1) a main body 906 in communication with the line cord 902 operationally configured as a housing for a drive motor, the main body 906 including an outer surface having a grip portion 907 for manual holding of the angle grinder 900, (2) a power switch or switch paddle 908 disposed along the main body 906, (3) a head portion 910 removably attached at the front end of the main body 906 via a plurality of fasteners 918, the head portion 910 including a drive shaft (not shown) for attachment of an accessory such as a grinding disc 914 and (4) a wheel guard 916.

The head portion 910 of the angle grinder 900 also includes threaded apertures 920A-920C at different locations about the head portion 910 for receiving a threaded spindle of a side handle 922 providing three different positions for a side handle 922 about the angle grinder 900. Other known angle grinders include only two threaded apertures for receiving a side handle 922 on opposite sides of the head portion 910, e.g., for receiving a side handle 922 at positions 920A and 920C.

A typical right-handed side handle 922 attachment is shown in FIG. 2. As common in prior art hand held power tools, a side handle 922 must be physically removed from one threaded aperture, e.g., aperture 920A, in order to then be mated with another threaded aperture, e.g., aperture 920B or aperture 920C. Such a configuration unfortunately provides opportunity for an angle grinder 900 operator to completely remove the side handle 922 from the angle grinder 900 during operation—a safety violation in many circumstances and on various job sites.

The present invention is operationally configured to reduce or otherwise eliminate the opportunity of impropriety in regard to the verboten removal of side handles and/or side handle assemblies from hand held power tools including angle grinders. In particular, the present invention is directed to a novel hand held power tool assembly operationally configured to provide desired side handle adjustment in a tamper-proof construction.

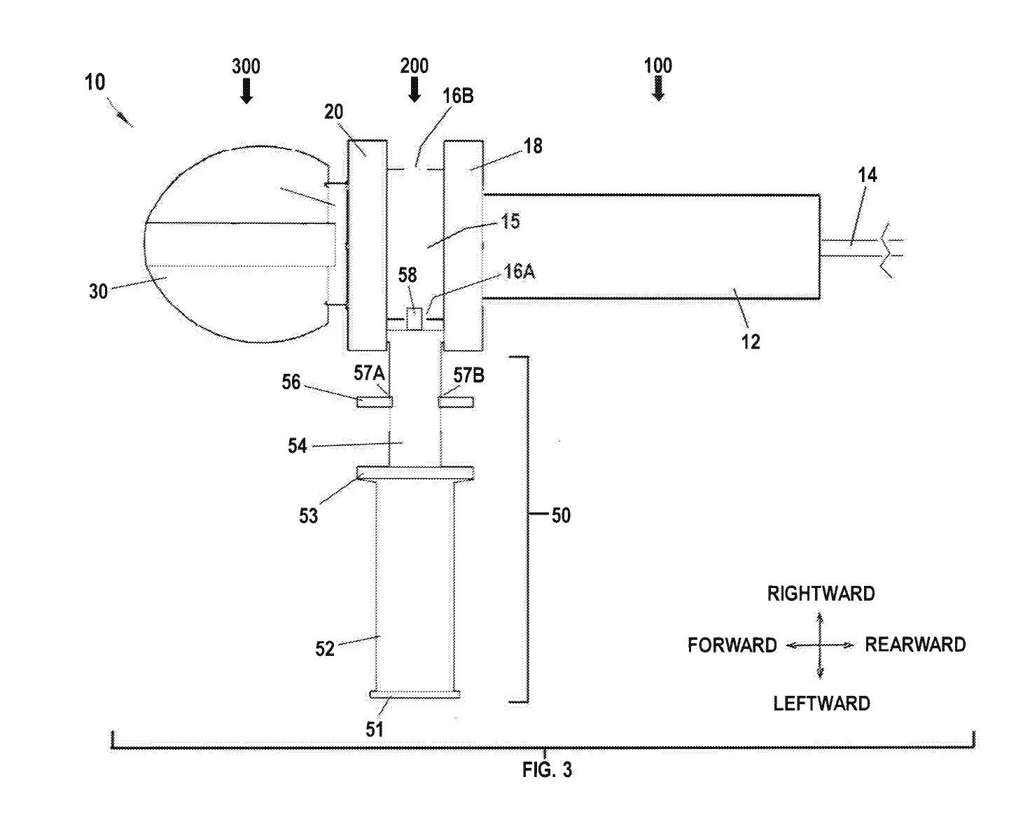

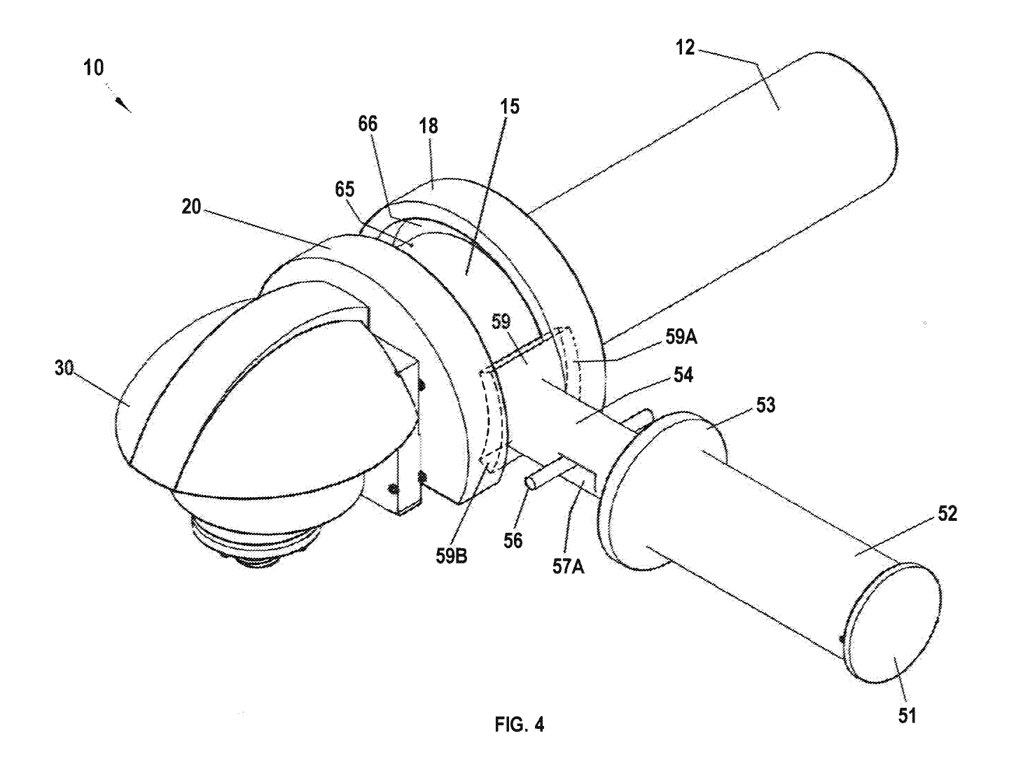

A first simplified embodiment of the present invention is provided in the form of a hand held corded angle grinder 10 (hereafter “grinder 10”) as shown in FIGS. 3 and 4. In this non-limiting embodiment, the grinder 10 is provided in three main sections, namely, a first section 100, a second section 200 and a third section 300 operationally configured for assembly and disassembly. In another embodiment, the grinder 10 may include a different configuration and/or a different number of main sections as may be desired. Also, although the present grinder 10 is depicted as a corded type hand tool, in another embodiment the grinder 10 may be provided as a cordless type hand tool.

As shown, the first section 100 of the grinder 10 suitably includes a main body or “body 12” operationally configured to house a motor therein similar as described above in reference to the prior art of FIGS. 1 and 2. The grinder 10 suitably includes an electric power cord 14 extending out from a rearward end of the grinder 10 operationally configured to provide power to the motor housed in the body 12. As understood by the skilled artisan, the body 12 suitably has an outer surface operationally configured to be held with a single hand or with two hands in a manner similar as other commercially available grinders. Although the body 12 is shown as a cylindrical member, other shapes and surface configurations are herein contemplated as may be desired or as may otherwise be required for a particular power hand tool (see the main body 906 in FIG. 1). For example, a body 12 may include a contoured surface and/or finger grooves for hand gripping enhancement. In addition, similar as known hand held power tool, the body 12 may also include one or more outer surface materials, e.g., rubber surfaces, tacky surfaces, anti-slip surfaces, effective to enhance hand gripping and/or prevent hand slippage during operation of the grinder 10. A skilled artisan will appreciate the many modifications that may be made to a surface of the body 12 for handling purposes.

With further reference to FIGS. 3 and 4, the second section 200 of the grinder 10 is operationally configured to interconnect the first and third sections 100, 300 and serves as the location for attachment or securement of a side handle assembly 50 of the grinder 10, while the third section 300, located at the forward end of the grinder 10, provides the working rotary end or “head 30” of the grinder 10. Herein, the internal workings of the grinder 10 and the third section may be configured for operation similar as the angle grinder 900 of FIGS. 1 and 2.

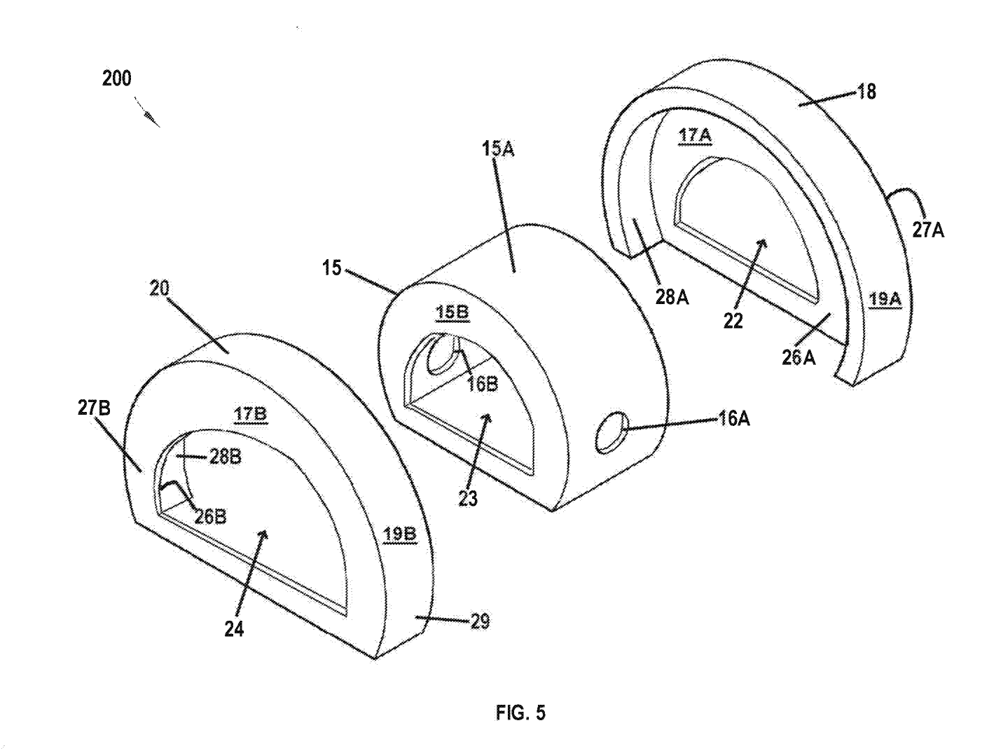

One suitable second section 200 may include an assembly comprised of component parts as shown in FIG. 5 effective to provide a tamper-proof side handle or side handle assembly for a grinder 10 that may be directed to and held in one or more fixed positions about the second section 200 as desired. In this embodiment, the component parts include a first guard member 18, an opposing second guard member 20 and tracking body member 15 located between the first and second guard members 18, 20. As shown, the first and second guard members 18, 20 include (1) wall members 17A, 17B defined by planar inner surfaces 26A, 26B and planar outer surfaces 27A, 27B and (2) perimeter rims 19A, 19B defined by non-planar inner surfaces 28A, 28B and non-planar outer surfaces 29A, 29B. Once assembled, the first and second guard members 18, 20 are operationally configured to sandwich part of the tracking body member 15 there between whereby the perimeter rims 19A, 19B overhang part of the outer surface 15A of the tracking body member 15 forming an open space there between (see FIG. 4).

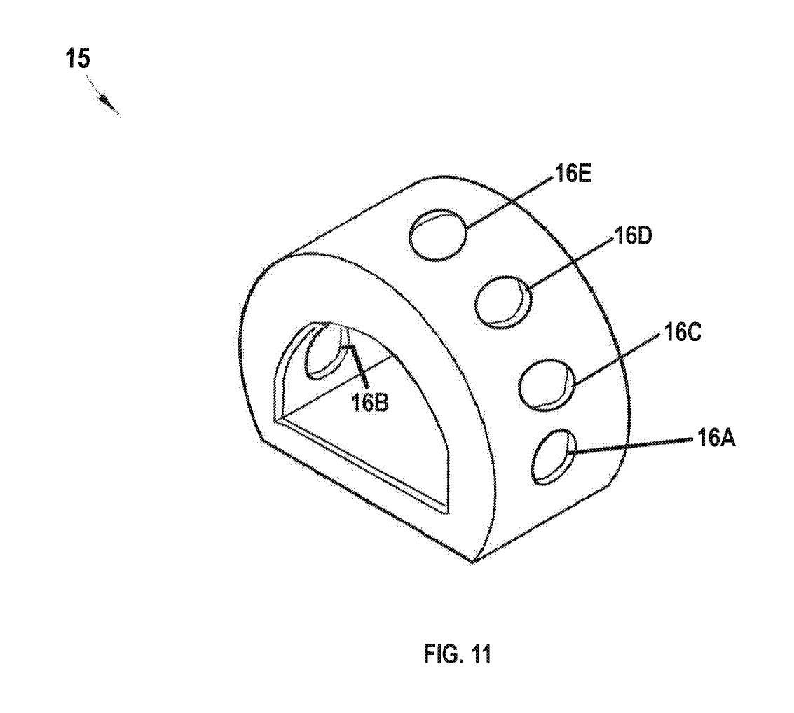

With further reference to FIG. 5, the outer surface 15A of the tracking body member 15 suitably includes a plurality of handle position apertures 16A, 16B operationally configured to receive part of a side handle assembly 50 in a mated position there through in a manner effective to set the side handle assembly 50 at a fixed position during grinder 10 operation. In another embodiment, the outer surface 15A of the tracking body member 15 may include cavities or the like for receiving at least part of a side handle assembly 50 in a mated position therein in a manner effective to set the side handle assembly 50 at a fixed position during grinder 10 operation. Although the tracking body member 15 is described as having two position apertures 16A and 16B 180.0 degrees apart, the tracking body member 15 may include any number of position apertures as desired (see position apertures 16C-16E in FIG. 11) according to the space limitations of the second section 200 and corresponding side handle assembly 50 up to 360.0 degrees. Herein, the second section 200 and the side handle assembly 50 may be collectively referred to as a “side handle positioning assembly” of the grinder 10.

As further seen in FIG. 5, the tracking body member 15 may include at least one wall member 15B providing structural support to the tracking body member 15. Suitably, the wall member 15B, and the wall members 17A, 17B each include openings 22, 23, 24 there through effective to provide a continuous open internal housing for the mechanical and/or electrical component parts from the rearward end to the forward end of the grinder 10. The openings 22, 23, 24 are not necessarily limited in size and/or shape, but rather are provided in a size and/or shape effective for operation of component parts housed within the grinder 10. One exemplary internal configuration of a suitable grinder 10 includes, but is not limited to the working parts as described in U.S. Pat. No. 6,632,128, entitled “Angle Grinder with electric drive,” with an issue date of Oct. 14, 2003, the content of which is herein incorporated by reference in its entirety. Another exemplary internal configuration of a grinder 10 described herein includes, but is not limited to the working parts as described in U.S. Pat. No. 8,087,977, entitled “Angle Grinder,” with an issue date of Jan. 3, 2012, the content of which is herein incorporated by reference in its entirety.

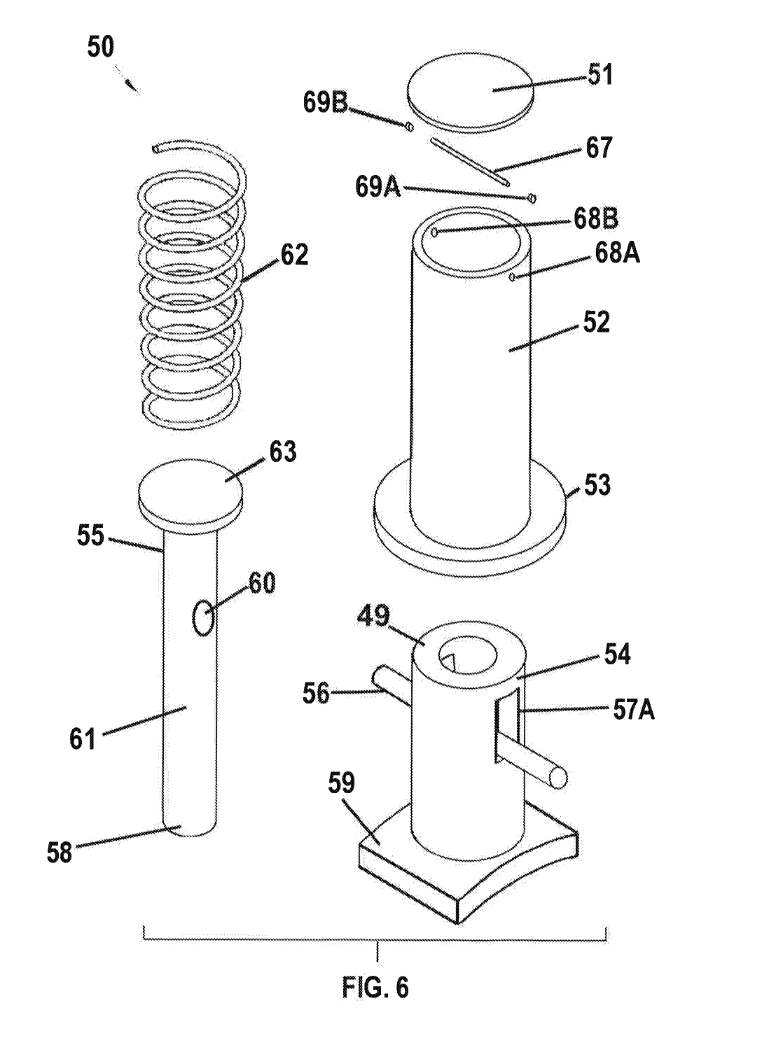

With attention to FIG. 6, one exemplary side handle assembly 50 for use with the second section 200 described above includes at least a main handle member 52 (“handle 52”), an intermediate pin housing 54, an internal locking shaft 55 and a biasing member 62. One suitable handle 52 includes a hollow member defined by a longitudinal axis with an outer surface for hand grasping and an internal surface for housing a biasing member 62 and at least part of the pin housing 54 therein. In particular, the handle 52 includes an open proximal end operationally configured to receive a distal end 49 of a pin housing 54 in a mated position therein. In another embodiment, the handle 52 and intermediate pin housing 54 may be provided as a one-piece construction for non-removable attachment to the grinder 10.

The biasing member 62 may also be inserted into the open proximal end of the handle 52 or into the open distal end as desired. To enhance gripping of the handle 52 by hand, the outer surface of the handle 52 may include a contoured surface, one or more slip resistant features and/or materials including, but not necessarily limited to parallel rows of grooves therein, a plurality of raised bumps or protrusions, a knurl pattern, finger grooves and/or a tacky material applied to the surface of the handle 52 including, but not necessarily limited to one or more rubber materials.

In this embodiment, the pin housing 54 is also provided as a hollow member defined by a longitudinal axis concentrically aligned with the longitudinal axis of the handle 52 when mated with the handle 52. Once assembled, the handle 52 and pin housing 54 are operationally configured to house at least part of a biased locking shaft 55 therein, whereby a mating end 58 of the locking shaft 55 is operationally configured to extend out from the pin housing 54 in a manner effective for releasably mating with the position apertures 16A, 16B.

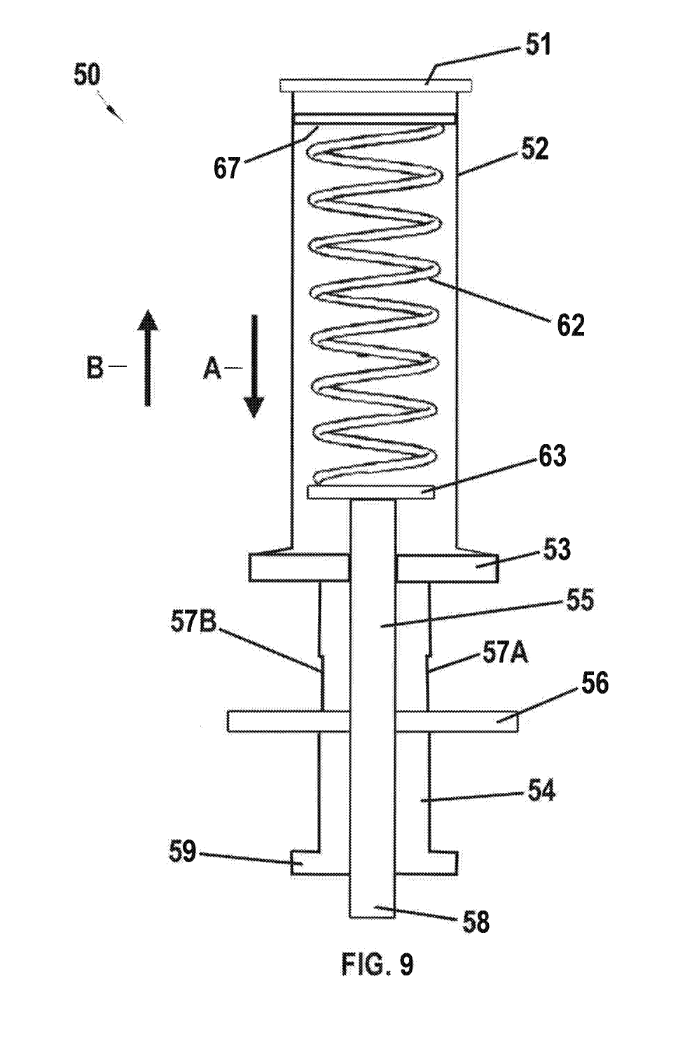

With further reference to FIG. 6, the pin housing 54 also includes a release pin 56 (or “release lever”) in communication with the locking shaft 55 effective for directing the locking shaft 55 linearly apart from the grinder 10 according to Directional Arrow B as shown in FIG. 9. In this embodiment, the release pin 56 includes a cylindrical member disposed through opposing apertures 57A, 57B of the pin housing 54 and a corresponding aperture 60 of the locking shaft 55 in a manner effective to extend out from opposing sides of the pin housing 54 for manual operation. The release pin 56 may be provided in another form as desired for manual operation, e.g., an elongated multi-sided member or a flattened planar type member.

As further shown in FIG. 6, the proximal open end of the pin housing 54 includes a projection member or enlarged skirt type member (hereafter referred to as “tracking member 59”) operationally configured to communicate with the assembled second section 200. Once assembled, the mating end 58 of the locking shaft 55 is suitably biased out (see Directional Arrow A in FIG. 9) beyond the tracking member 59 to a mated position within a position aperture, e.g., see the mated position of the mating end 58 with the position aperture 16A in FIG. 3. As mentioned above, the release pin 56 may be directed apart from the grinder 10 according to Directional Arrow B, which in turn directs the mating end 58 of the locking shaft 55 linearly out from a mated position with a position aperture. For example, the mating end 58 may be withdrawn from aperture 16A and relocated along the second section 200 of the grinder 10 to a mated position with the position aperture 16B.

Referring again to FIG. 4, once the grinder 10 is assembled the tracking body member 15, first guard member 18 and second guard member 20 are operationally configured to provide a travel channel 65 effective as an inner guide path or pathway for travel of a tracking member 59 therein. In this particular embodiment, the surfaces 26A, 26B, 28A, 28B of the first and second guard members 18, 20 and the outer surface 15A of the tracking body member 15 described above are operationally configured to provide an open space in the form of a curved open travel channel 65 or pathway of a size for receiving a curved tracking member 59 therein in a manner effective to (1) allow the tracking member 59 to travel along the length of the travel channel 65 while (2) maintaining the tracking member 59 in a secured non-removable position within the travel channel 65. As FIG. 4 illustrates, at least part of the tracking member 59 suitably projects out laterally to a greater width whereby the outer lateral sections 59A, 59B of the tracking member 59 extend within the opposing spaces 66 of the travel channel 65 in a manner effective to secure the side handle assembly 50 to the second section 200 in a non-removable arrangement. As understood by the skilled artisan, the tracking member 59 is suitably placed adjacent the outer surface 15A of the tracking body member 15 prior to assembly of the first and second guard members 18, 20 thereto.

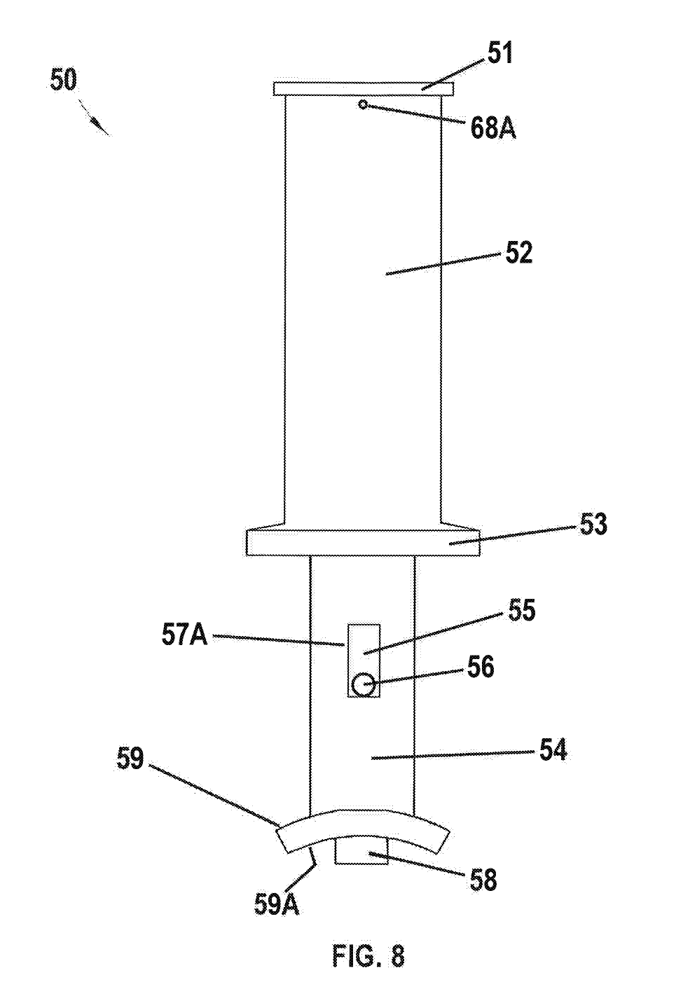

Turning to the simplified example of FIG. 8, one suitable tracking member 59 may include a curved tracking surface 59A of a radius substantially similar as the outer surface 15A of the tracking body member 15. In another embodiment, the tracking member 59 may be provided as a planar or plate type member as shown in FIG. 9 effective for travel within the travel channel 65. Regardless the shape of the tracking member 59 employed, the side handle assembly 50 is operationally configured to travel within the travel channel 65 of the second section 200 from a first mated position according to the location of aperture 16A to a second mated position according to the location of aperture 16B and vice versa in a tamper-proof type manner thereby preventing potential safety concerns and/or violations associated with the prohibited removal of side handles as discussed above.

Turning again to FIG. 6, the handle 52 may also include a hand guard 53 or similar member about its perimeter, although a hand guard or equivalent is not necessarily required for side handle assembly 50 operation. The handle 52 may also be provided with a removable end cap 51 for covering the open distal end of the handle 52. In one embodiment, an end cap 51 may attach to the distal end of the handle 52 via a snap-fit connection. In another embodiment, an end cap 51 may attach to the distal end of the handle 52 via a threaded connection.

Still referring to FIG. 6, a suitable locking shaft 55 includes a widened head portion 63 and an elongated member 61 extending there from defined by a longitudinal axis concentrically aligned within the handle 52 and the pin housing 54 once assembled. As shown in FIG. 9, the biasing member 62 housed within the handle 52 is operationally configured to contact the head portion 63 to bias the distal end 58 of the elongated member 61 of the locking shaft 55 to a mated position with the position apertures 16A, 16B according to Directional Arrow A.

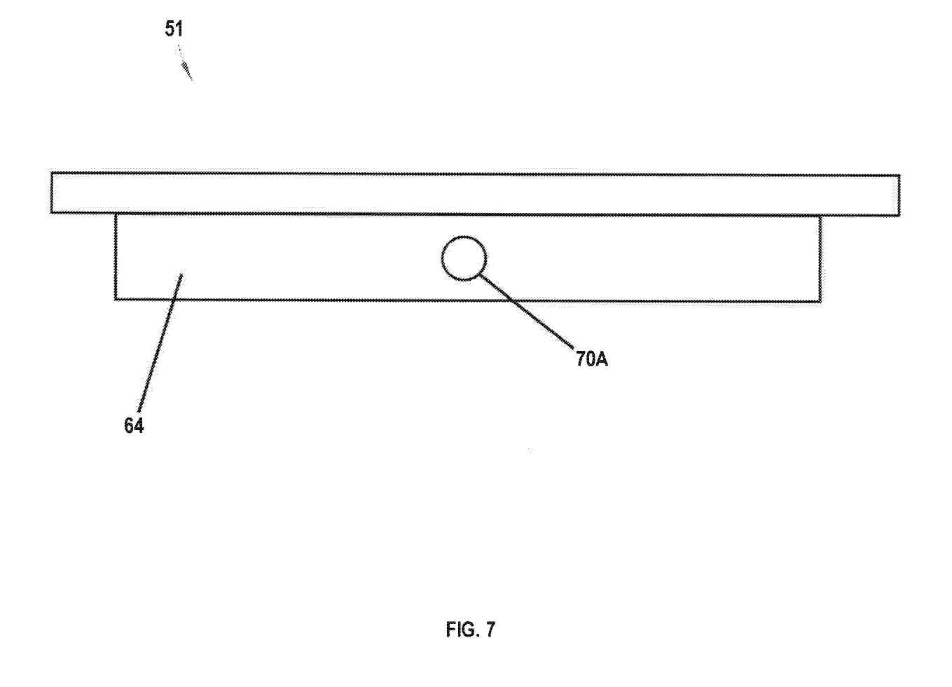

In one embodiment, the biasing member 62, shown in this embodiment as a steel coil spring, is suitably situated or positioned between a head portion 63 of the locking shaft 55 and the inner surface of the end cap 51 whereby the biasing member 62 applies opposing biasing forces to the end cap 51 and the head portion 63 in a manner effective to bias the locking shaft 55 directionally toward the position apertures 16A, 16B. With reference to FIG. 6, the side handle assembly 50 may also include a pin member 67 housed within the handle 52 operationally configured to hold a distal end of a biasing member 62 at a set position apart from the end cap 51 (see FIG. 9). In one embodiment, the pin member 67 may be fused or otherwise adhered to the inner surface of the handle 52. As shown in the embodiment of FIG. 6, the handle 52 may include opposing pin holes 68A, 68B there through for receiving opposing ends of the pin member 67 in a mated position therein. Pin caps 69A, 69B may also be inserted into the pin holes 68A, 68B for holding the pin member 67 in place during grinder 10 operation. As shown in FIG. 7, in an embodiment where the end cap 51 is provided as a snap-fit type member, the end cap 51 may include a neck 64 and opposing apertures 70A, 70B for receiving opposing ends of a pin member 67 therein, the neck 64 further maintaining the position of the pin member 67 during grinder 10 operation.

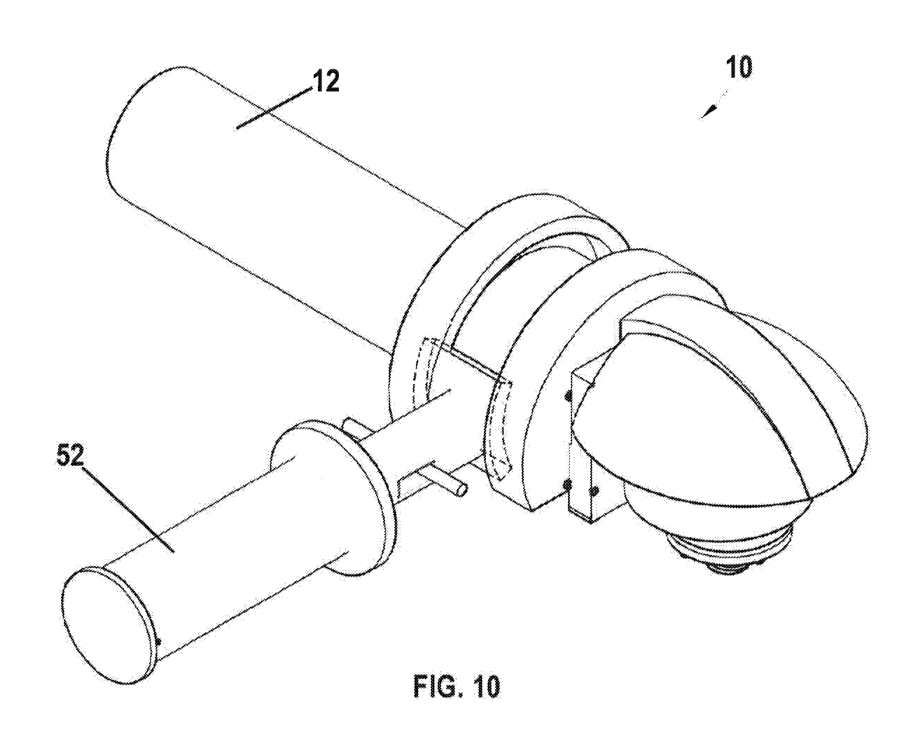

In operation of the grinder 10 described above, the grinder 10 may be assembled be setting a side handle assembly 50 at a first fixed position as shown in FIGS. 3 and 4 with the locking shaft 55 set in a mated position with aperture 16A according to the action of the biasing member 62 acting on the locking shaft 55—this first position may also be referred to herein as a “right-handed position” since it is common for right handed persons to hold the body 12 with their right hand and the handle 52 with their left hand. If a user desires to move the side handle assembly 50 to a second position or “left-handed position” as shown in FIG. 10, he/she may use his/her hand(s) to manually direct the release pin 56 directionally toward the handle 52 according to Directional Arrow B thereby directing the locking shaft 55 into the interior of the handle 52 allowing the distal end 58 of the locking shaft 55 to be released out from the aperture 16A. Once the locking shaft 55 is directed out from a mated position with aperture 16A, the side handle assembly 50 may be directed along the travel channel 65 until the distal end 58 of the locking shaft 55 is aligned with the opposing aperture 16B of the tracking body member 15. Once aligned, the user may allow the biasing member 62 to act on the locking shaft 55 in a manner effective to direct the distal end 58 of the locking shaft 55 to a mated position within aperture 16B according to Directional Arrow A.

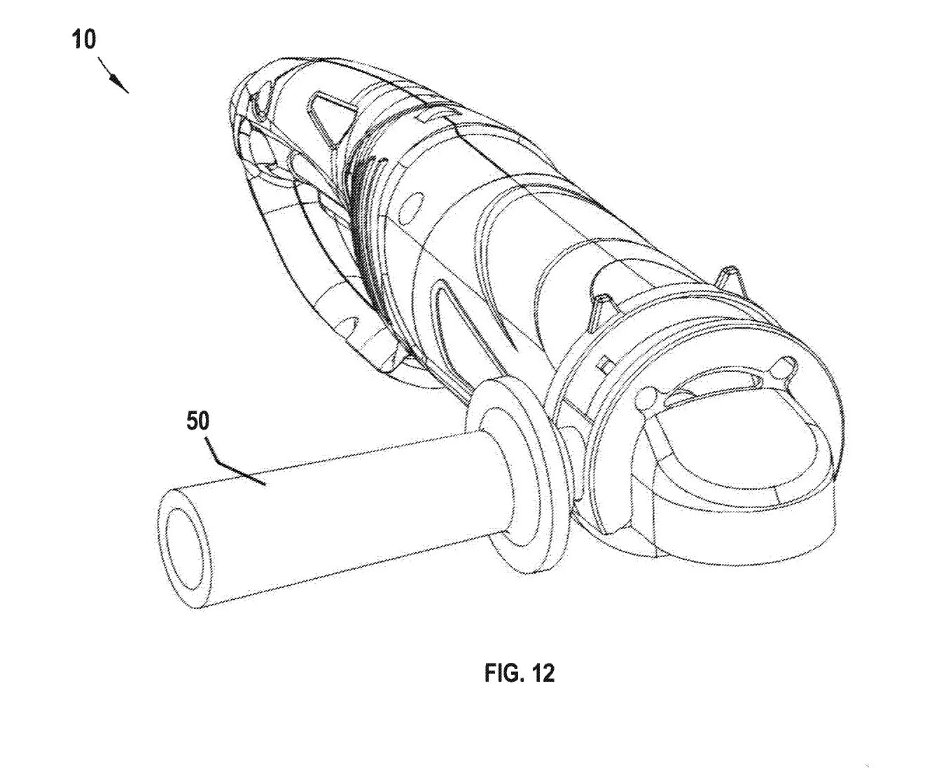

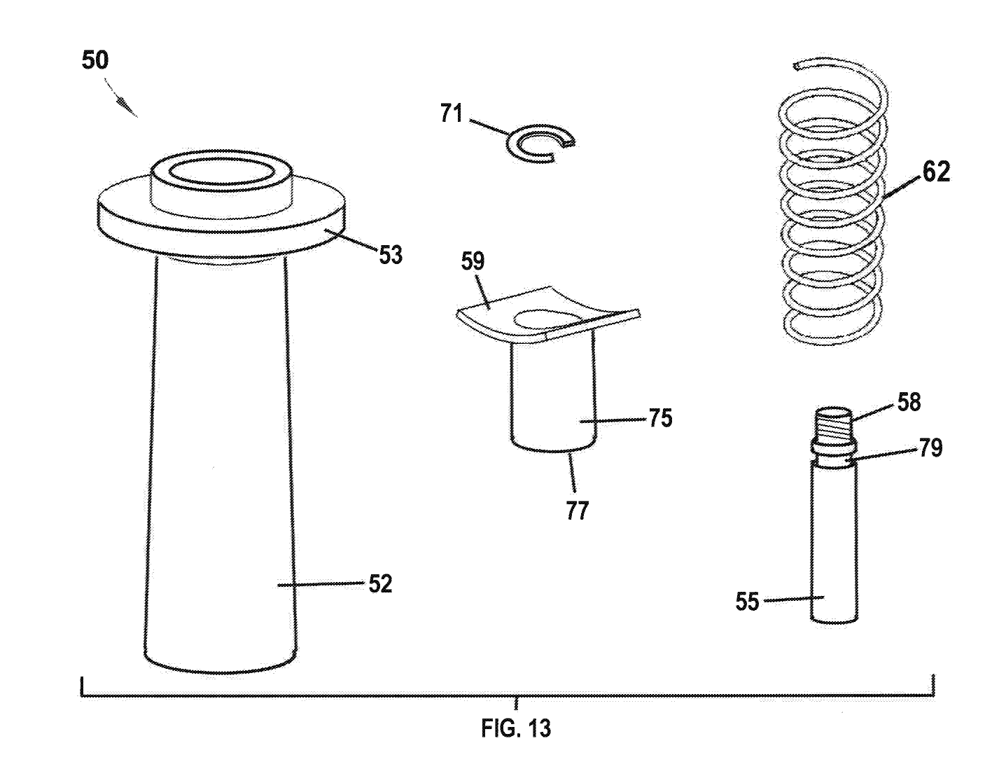

In another embodiment, a grinder 10 may be provided including a side handle positioning assembly as shown in FIG. 12. Similar as above, the side handle positioning assembly of this embodiment also includes an assembly of component parts includes a side handle assembly 50 comprised of various component parts that, once assembled, are operationally configured to releasably position the side handle assembly 50 in one of a plurality of locations about the second section 200 of the grinder 10 in a non-removable arrangement. In this embodiment, as seen in FIG. 13, the side handle assembly 50 includes at least a hollow handle 52, a hollow intermediate housing 75, a locking shaft 55, at least one biasing member 62 and a sir clip 71. As shown, the intermediate housing 75 includes a tracking member 59 at its proximal end similar as described above. In operation, the intermediate housing 75, biasing member 62 and locking shaft 55 suitably rest within the handle 51 in a manner effective for suitable interaction with the second section 200 of the grinder 10.

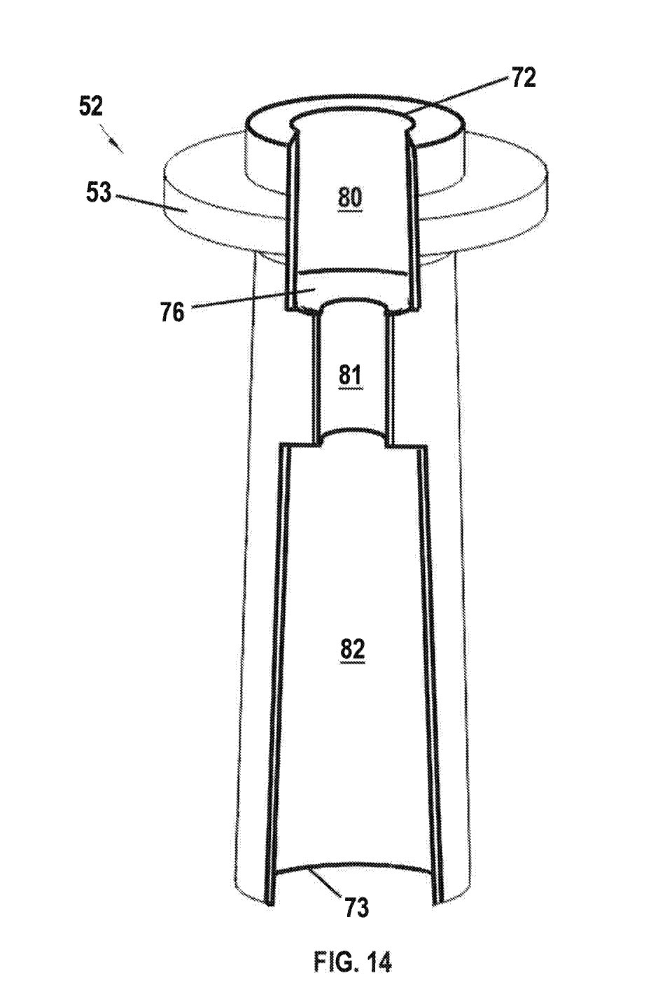

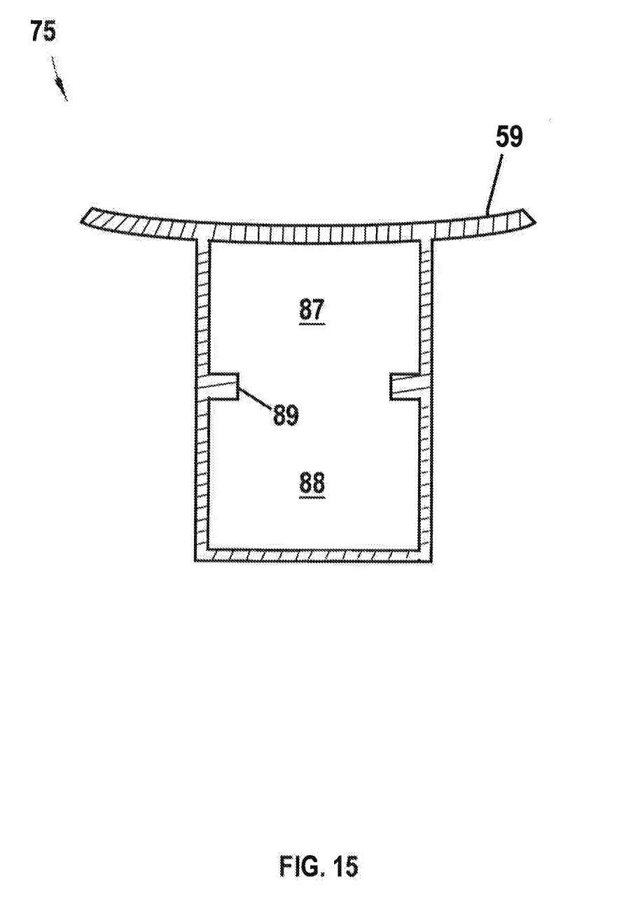

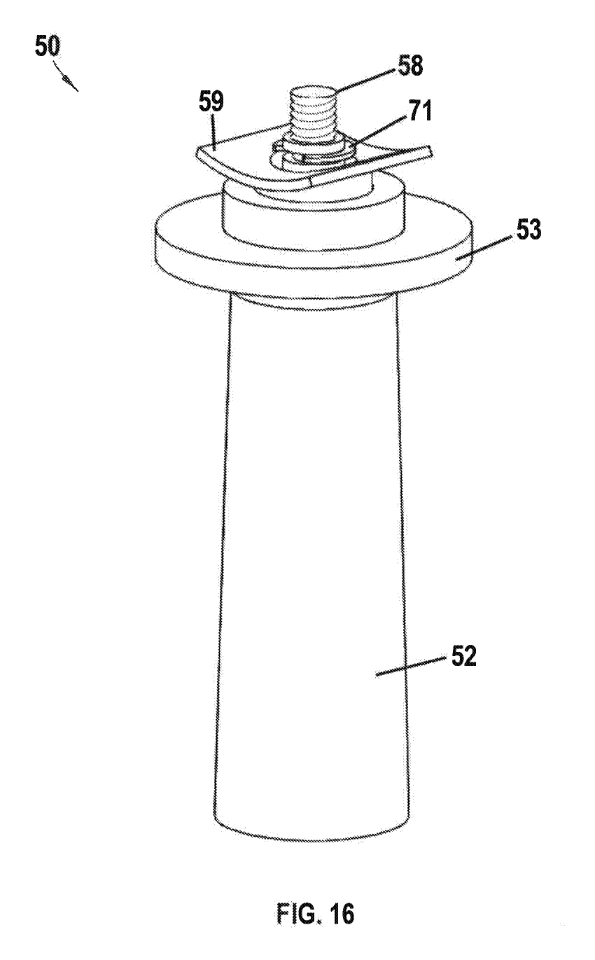

In this embodiment, the handle 52 suitably includes a first opening 72 at a proximal end and a second opening 73 at a distal end of the handle 52 with a non-uniform inner surface defining three separate open sections there through effective for assembly of the various component parts comprising the handle assembly 50. In particular, the first opening 72 defines a first inner section 80 of the handle 52 and the second opening 73 defines a third inner section 82 of the handle 52, with a second inner section 81 disposed between and interconnecting the first and third inner sections 80, 82 as shown in the simplified illustration of FIG. 14. With reference to FIG. 15, the intermediate housing 75 suitably includes a first inner section 87 and a second inner section 88 separated by an inner perimeter wall member 89 with an opening there through. A simplified illustration of an assembled side handle assembly 50 is shown in FIG. 16. Similar as discussed above, the present side handle assembly 50 may also include a removable end cap 51.

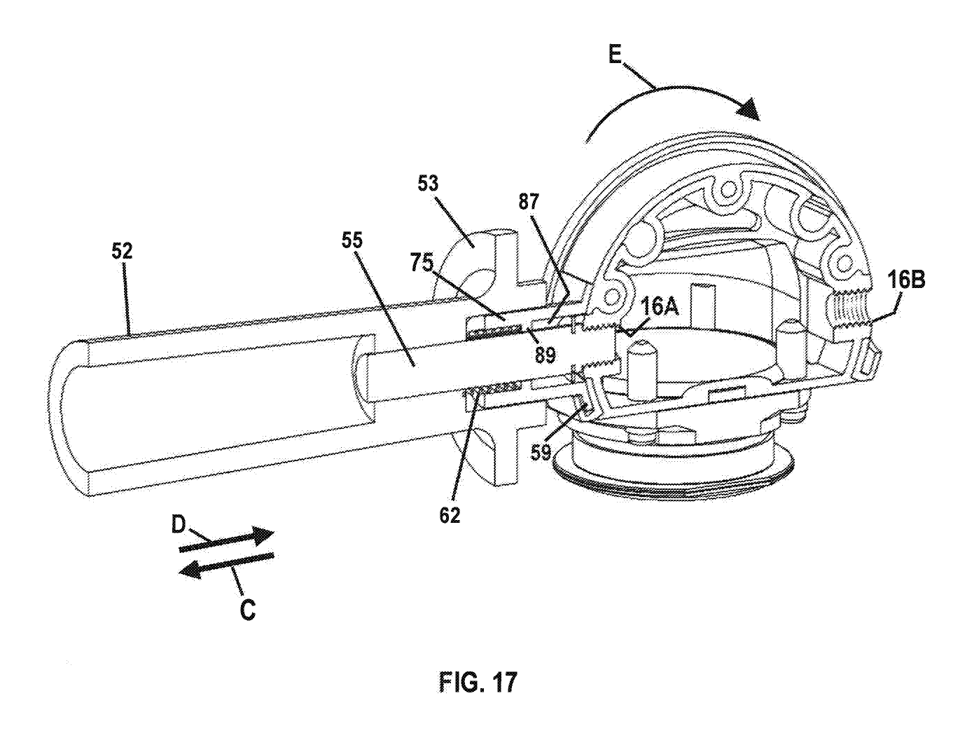

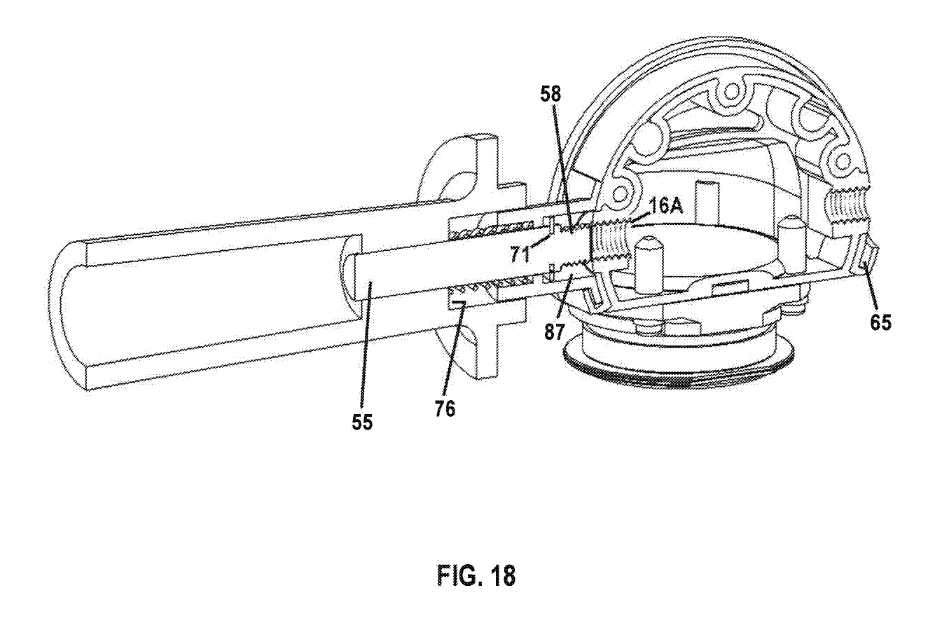

As shown in FIGS. 17 and 18, once assembled the intermediate housing 75 is suitably mated within the first inner surface 80 of the handle 52. In this embodiment, the first inner section 80 includes a cylindrical inner surface configuration corresponding to the cylindrical outer surface of the intermediate housing 75 providing for a flush fitting of the intermediate housing 75 therein. Suitably, the first inner section 80 includes a depth about equal to the length of the intermediate housing 75 wherein substantially the entire length of the intermediate housing 75 may be inserted into the first inner section 80. As shown, the depth of the first inner section 80 is determined according to the location of the inner surface 76 defining the second inner section 81. As further shown, at least part of the biasing member 62 is located within the second inner section 88 of the intermediate housing 75 and suitably extends out from the intermediate housing 75 when the intermediate housing 75 is set apart from the inner surface 76 as shown. In operation, the biasing member 62 is effective to apply opposing forces to the wall member 89 and the inner surface 76 for biasing the handle 52 apart from the grinder 10 according to Directional Arrow C.

With particular reference to FIG. 17, the locking member 55 suitably extends from the third inner section 82, through the second inner section 81 and out through both the first opening 72 of the handle 52 and the proximal end of the intermediate housing 75 to a mated position with a position aperture of the second section 200, e.g., position aperture 16A. In this embodiment, the position apertures 16A and 16B are provided as threaded apertures for communicating with a threaded mating end 58 of the locking member 55 in a manner effective to receive the mating end 58 in a fixed position therein as shown. As described below, the locking member 55 is suitably fixed to the handle 52 in a manner effective so that the handle 52 and locking member 55 turn simultaneously clockwise and counterclockwise for positioning the mating end 58 within one of the apertures 16A and 16B (see FIG. 17) and for removing the mating end 58 out from one of the apertures 16A and 16B (see FIG. 18).

As further shown in FIGS. 17 and 18, the first inner section 80 is operationally configured to receive the intermediate housing 75 slideably therein whereby the handle 52 may freely turn about the intermediate housing 75 and travel lengthwise along the outer surface of the intermediate housing 75 to a fully mated position according to an abutment position between the distal end 77 of the intermediate housing 75 and the inner surface 76 of the handle 52. In particular, the handle 52 is maintained in an assembled orientation with the intermediate housing 75 via the locking member 55 disposed there through and the intermediate housing 75 is maintained in an attached position with the second section 200 of the grinder 10 via the tracking member 59, which is mated with the travel channel 65 similar as described above. In this embodiment, the locking member 55 is maintained in an attached position with the intermediate housing 75 via the sir clip 71 which is attached to a channel portion 79 of the locking member 55 and extends out from the locking member 55 effective for preventing the mating end 58 of the locking member 55 from traveling passed the wall member 89 into the second inner section 88 of the intermediate housing 75 by acting as a stop against the wall member 89.

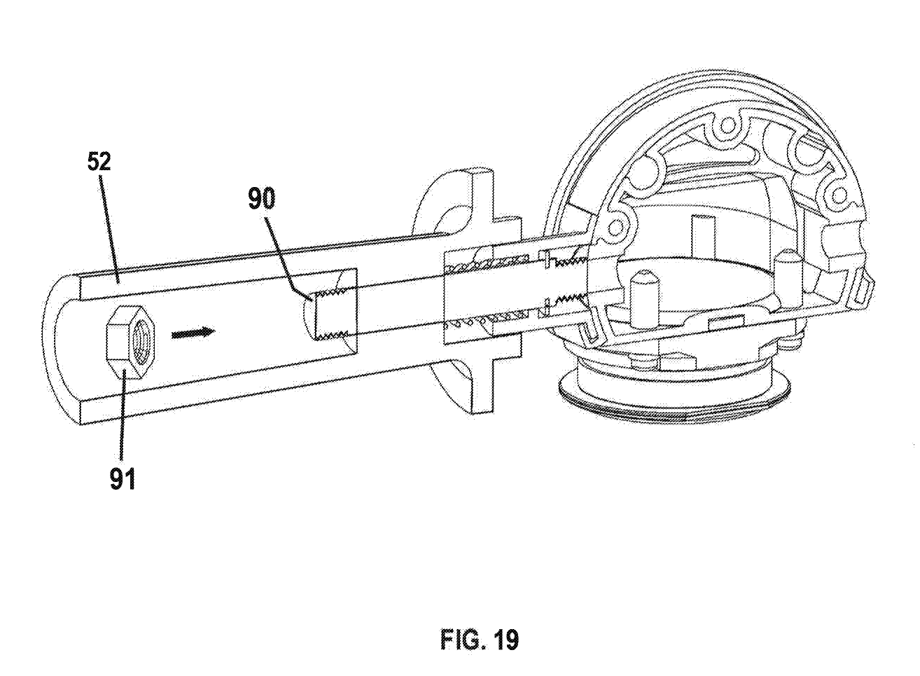

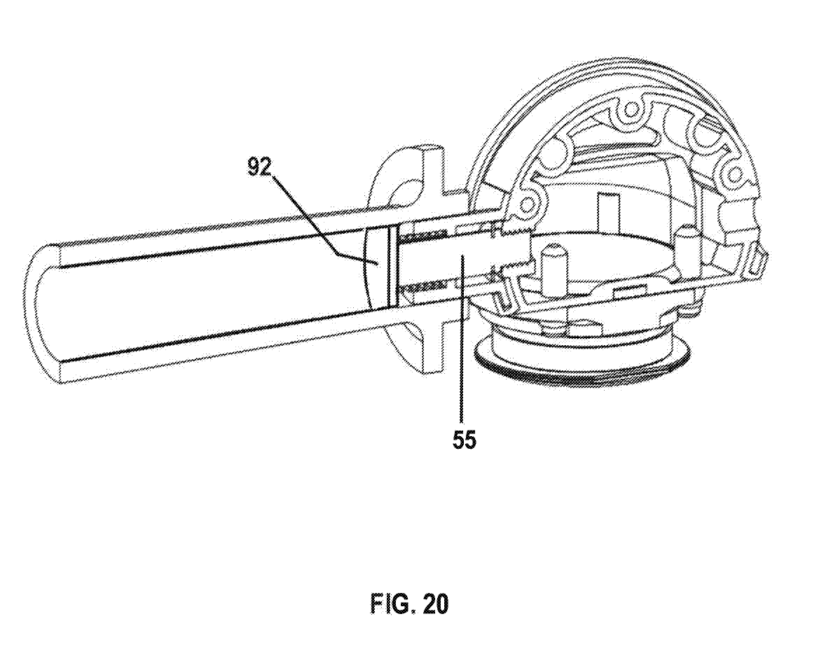

Suitably, the opening through the wall member 89 and the second inner section 81 of the handle 52 are effective to receive the outer surface of the locking member 55 in a flush orientation effective for maintaining the concentric alignment of the locking member 55 with the handle 52 during operation. In operation, the locking member 55 is suitably fixed to the handle 52 but freely turns within the opening of the wall member 89. For example, in one embodiment the locking member 55 may be provided as part of the handle 52 as a one-piece construction as shown in FIGS. 17 and 18. In another embodiment, the distal end 90 of the locking member 55 may include threads for receiving a threaded nut 91 in a manner effective to hold the locking member 55 in a fixed orientation relative the handle 52 (see FIG. 19). Another embodiment including a locking member 55 provided as a one-piece construction as part of the handle 52 is shown in FIG. 20 wherein the locking member 55 extends out from an inner surface 92 of the handle 52 as shown.

Herein, the handle 52 includes a length suitable to be held or gripped by an adult sized hand although the handle 52 may include a greater length as desired. To enhance gripping of the handle 52 by hand, the outer surface of the handle 52 may include a contoured surface, one or more slip resistant features and/or materials including, but not necessarily limited to parallel rows of grooves therein, a plurality of raised bumps or protrusions, a knurl pattern, finger grooves and/or a tacky material applied to the surface of the handle 52 including, but not necessarily limited to one or more rubber materials. As shown, the handle 52 may also include a hand guard 53 extending out from its outer surface operationally configured as a hand stop and/or barrier effective to maintain a user's apart from the grinder 10.

In operation, the handle 52 and locking member 55 attached thereto may be turned counterclockwise to remove or disengage the mating end 58 of the locking member 55 out from the position aperture 16A as shown in FIG. 18. In this position, the biasing member 62 is effective for holding the locking member 55 apart from the position aperture 16A according to the biasing action of the biasing member 62 according to Directional Arrow C. To reinsert the mating end 58 back into the position aperture 16A, the handle 52 and locking member 55 may be directed toward the grinder 10 according to Directional Arrow D until the mating end 58 reaches or engages the position aperture 16A and then the handle 52 and locking member 55 may be turned clockwise until the mating end 58 is threaded within the position aperture 16A as shown in FIG. 17. If a user wishes to insert the mating end 58 into position aperture 16B, the side handle assembly 50 may be directed to the opposite side of the grinder 10 (see Directional Arrow E) and inserted within position aperture 16B in a similar manner as described above in reference to position aperture 16A.

As shown in the various figures of this application, variations in the grinder 10 design may be provided as desired or as otherwise required by rule or regulation. In addition, the one or more parts making up the grinder 10 may be constructed from one or more materials suitable for providing operative structural support in connection with grinder 10 operation including, but not necessarily limited to those materials used to construct known angle grinders and other hand power tools as is appreciated by persons of ordinary skill in the art. Suitable materials include, but are not necessarily limited to, those materials resistant to chipping, cracking, excessive bending and reshaping as a result of weathering, heat, moisture, other outside mechanical and chemical influences, as well as impacts to the grinder 10. Particular materials may include, but are not necessarily limited to metals, plastics, rubbers, filled composite materials, and combinations thereof. Suitable metals include ferrous metals and non-ferrous metals. Suitable ferrous metals may include, but are not necessarily limited to mild steel, carbon steel, stainless steel, cast iron, and combinations thereof. Suitable non-ferrous metals include, but are not necessarily limited to aluminum, aluminum alloy, and combinations thereof. Other suitable metals may include titanium, titanium alloys such as nickel-titanium and titanium-aluminum-vanadium alloys, and combinations thereof. Suitable plastics may include, but are not necessarily limited to vinyl polymers, polyvinyl chloride (“PVC”), acrylonitrile butadiene styrene (“ABS”), bioplastics, polycarbonate, and combinations thereof. In addition, various component parts may be joined together via welds, adhesive materials, fasteners, and combinations thereof depending on the materials of construction used and/or the purpose of a particular grinder 10.

The invention will be better understood with reference to the following non-limiting examples, which are illustrative only and not intended to limit the present invention to a particular embodiment.

### Example 1

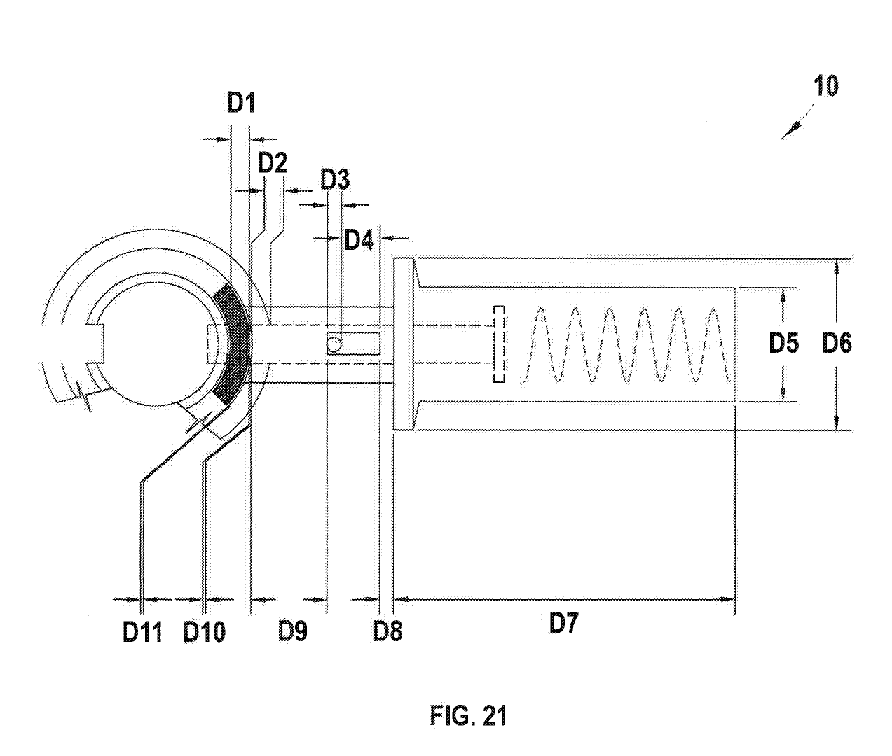

In a first non-limiting example, a grinder 10 as shown in FIG. 21 is provided having the following dimensions:

| | |
|---|---|
| D1: | 0.64 cm (0.25 inches) |
| D2: | 0.64 cm (0.25 inches) |
| D3: | 0.48 cm (0.19 inches) |
| D4: | 1.27 cm (0.50 inches) |
| D5: | 3.81 cm (1.50 inches) |
| D6: | 5.72 cm (2.25 inches) |
| D7: | 11.3 cm (4.44 inches) |
| D8: | 0.48 cm (0.19 inches) |
| D9: | 2.54 cm (1.00 inches) |
| D10: | 0.08 cm (0.03 inches) |
| D11: | 0.08 cm (0.03 inches). |

### Example 2

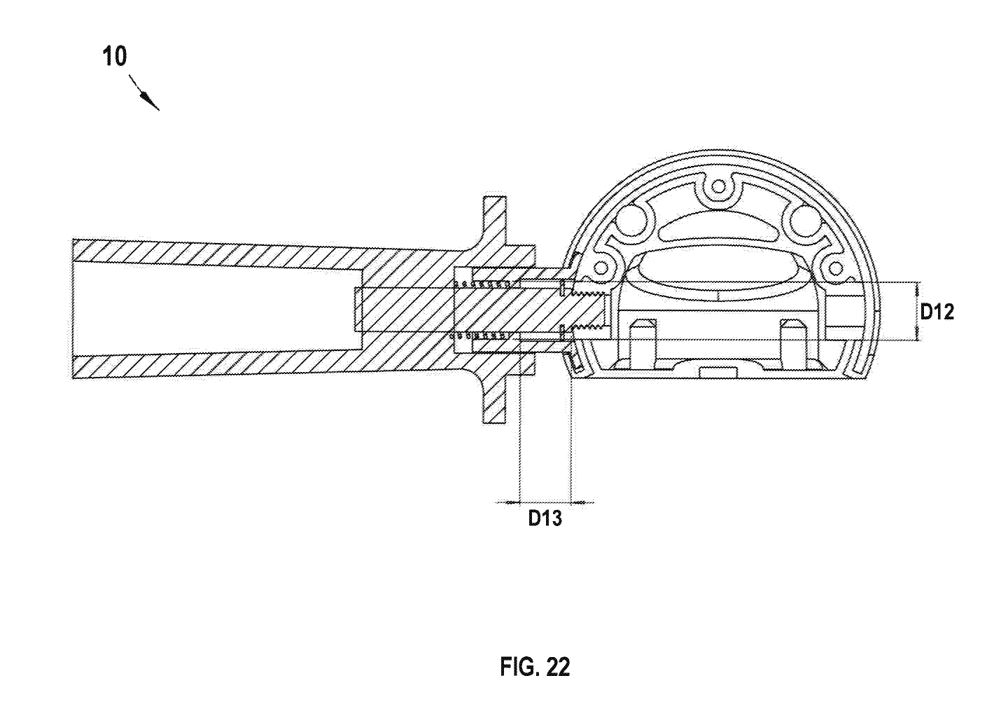

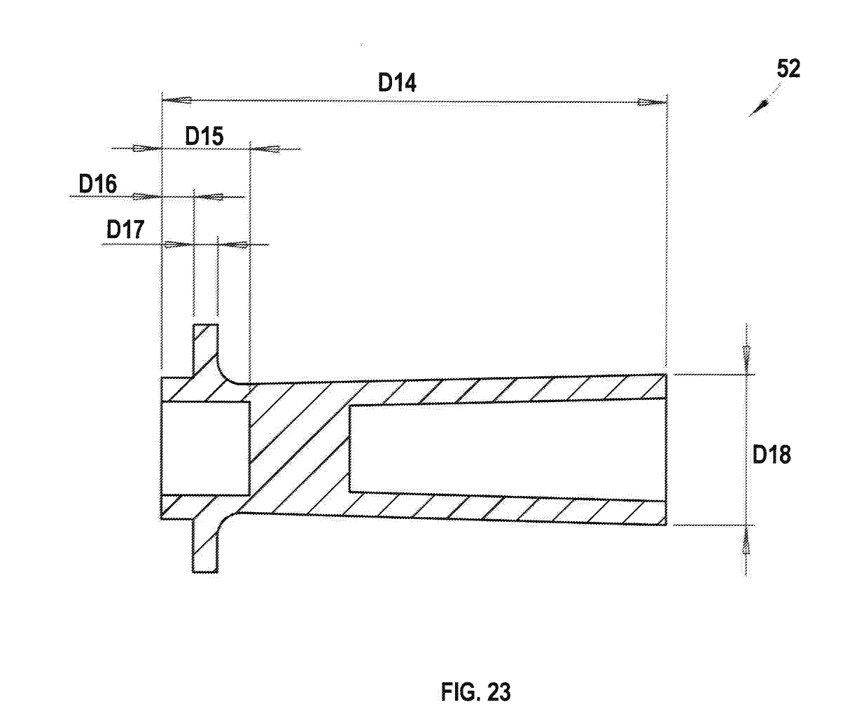

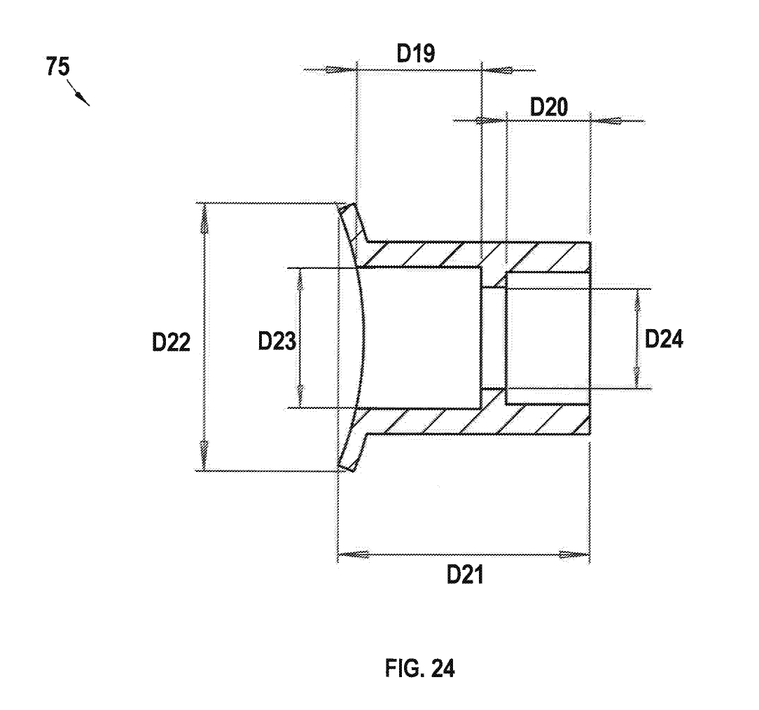

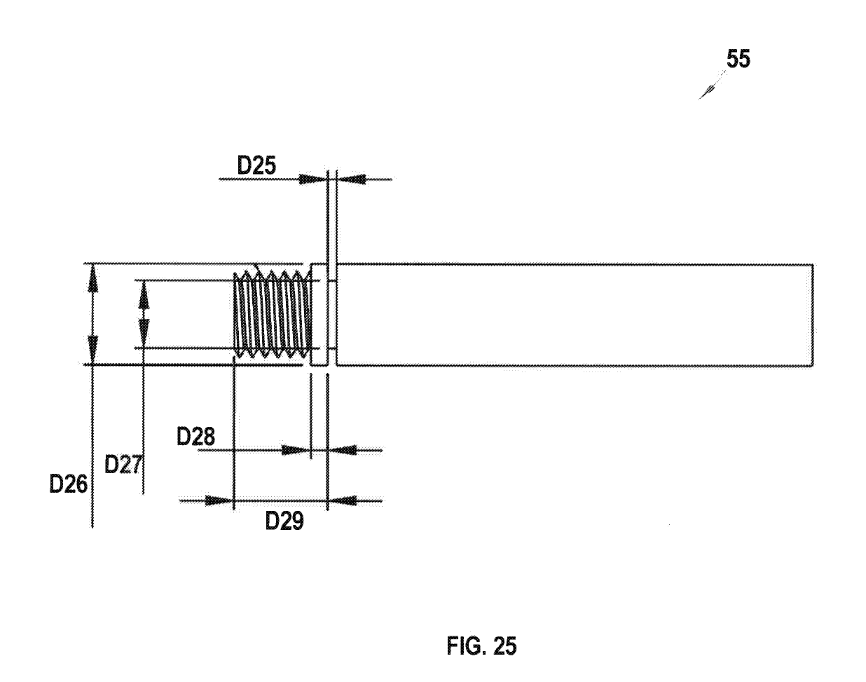

In a second non-limiting example, with reference to FIGS. 22-25, a grinder 10 and side handle assembly 50 are provided having the following dimensions:

| | | |
|---|---|---|
| D12: | 15.88 mm | (0.63 inches) |
| D13: | 14.0 mm | (0.55 inches) |
| D14: | 126.0 mm | (4.96 inches) |
| D15: | 22.0 mm | (0.87 inches) |
| D16: | 8.0 mm | (0.31 inches) |
| D17: | 6.0 mm | (0.24 inches) |
| D18: | 38.0 mm | (1.50 inches) |
| D19: | 14.91 mm | (0.59 inches) |
| D20: | 10.0 mm | (0.39 inches) |
| D21: | 30.04 mm | (1.18 inches) |
| D22: | 32.15 mm | (1.27 inches) |
| D23: | 15.88 mm | (0.63 inches) |
| D24: | 12.2 mm | (0.48 inches) |
| D25: | 1.05 mm | (0.04 inches) |
| D26: | 12.0 mm | (0.47 inches) |
| D27: | 8.0 mm | (0.31 inches) |
| D28: | 2.0 mm | (0.08 inches) |
| D29: | 11.0 mm | (0.43 inches) |

Although the invention is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed device, system and method, whether or not such embodiments are described and whether or not such features are presented as being a part of a described embodiment. Thus, the breadth and scope of the claimed invention should not be limited by any of the above-described embodiments. Persons of ordinary skill in the art will recognize that many modifications may be made to the present application without departing from the spirit and scope of the invention. The embodiment(s) described herein are meant to be illustrative only and should not be taken as limiting the invention, which is defined in the claims.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more.” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package.

I claim:

1. A hand held power tool including a non-removable side handle adjustable between two or more fixed positions about the hand held power tool.

2. The hand held power tool of claim 1 comprising an inner channel operationally configured to receive part of the side handle therein.

3. The hand held power tool of claim 2 wherein the inner channel extends at least 180.0 degrees about the hand held power tool.

4. A hand held power tool including a tamper-proof side handle assembly adjustable between two or more fixed positions about the power hand tool.

5. The hand held power tool of claim 4 including an inner channel operationally configured to receive part of the side handle assembly therein.

6. The hand held power tool of claim 5 wherein the side handle assembly includes a projection member operationally configured to travel within the inner channel.

7. The hand held power tool of claim 4 further including two or more apertures for receiving part of the side handle assembly therein.

8. The hand held power tool of claim 7 wherein the two or more apertures are threaded apertures.

9. An angle grinder including a non-removable side handle, the angle grinder including a channel at a depth within the grinder operationally configured to receive at least part of the side handle therein in a manner effective to fix the side handle in two or more positions about the angle grinder up to 180.0 degrees.

10. The angle grinder of claim 9 including an assembly of component parts operationally configured to form the channel.

11. The angle grinder of claim 9 further including a biasing member housed within the side handle.
